(19) United States
(12) Patent Application Publication
(10) Pub. No.: US 2006/0031607 A1
(43) Pub. Date: Feb. 9, 2006

(54) Systems and methods for managing input ring buffer

(75) Inventor: Frank Berreth, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/912,995

(22) Filed: Aug. 5, 2004

(51) Int. Cl. G06F 13/38

(52) U.S. Cl. 710/52

(57) ABSTRACT

Systems and methods for managing input ring buffer data transfers are described. In one aspect, a set of data packets from an output ring buffer (ORB) are sent to a codec. Information associated with the data packets is provided by a device driver. The data packets are stored in the ORB. The device driver is notified of any invalid response corresponding to a data packet of the data packets.

### TECHNICAL FIELD

The technical field pertains to bus driver data transfers.

### BACKGROUND

In systems that allow multiple device drivers to communicate with respective ones of multiple audio codecs on a one-to-one data packet (e.g., a command) and response basis, a device driver expects to receive a response for each command sent to an audio codec. Unfortunately, there are numerous reasons why such matching responses from audio codec(s) may not be forthcoming. One reason, for example, is that an audio codec response may be dropped due to dynamic memory allocation (DMA) engine FIFO buffer overflow. Another reason, for example, is that a codec response may never be generated for an associated device driver command if a targeted codec malfunctions. In such scenarios, there would not be a one-to-one matched response for each command sent by a device driver to an audio codec.

If there is not a one-to-one matched response for each command sent by a device driver to an audio codec, it will be difficult for an audio bus driver to determine which, if any, response stored in a input ring buffer (IRB) should be communicated to a particular device driver responsive to a particular command. One implementation of an IRB is a Response Input Ring Buffer (RIRB). To make matters worse, unsolicited notifications from audio codec(s) may also be stored in the IRB. Such unsolicited notification storage further obfuscates one-to-one matching of device driver commands to responses. In view of the above, systems and methods for managing IRB data transfers in systems that expect a one-to-one matching of device driver commands to audio codec responses would be very useful.

### SUMMARY

Systems and methods for managing input ring buffer data transfers are described. In one aspect, a set of data packets from an output ring buffer (ORB) are sent to a codec. Information associated with the data packets is provided by a device driver. The data packets are stored in the ORB. The device driver is notified of any invalid response corresponding to a data packet of the data packets.

### BRIEF DESCRIPTION OF THE DRAWINGS

In the figures, the left-most digit of a component reference number identifies the particular figure in which the component first appears.

FIG. 1 shows an exemplary system for managing input ring buffer (IRB) data transfers. In one implementation, an IRB is a RIRB.

FIG. 2 shows an exemplary procedure to manage IRB data transfers.

FIG. 3 shows further aspects of the exemplary procedure of FIG. 2 for managing IRB data transfers.

FIG. 4 shows an exemplary suitable computing environment on which systems, apparatuses and methods for managing IRB data transfers may be fully or partially implemented.

### DETAILED DESCRIPTION

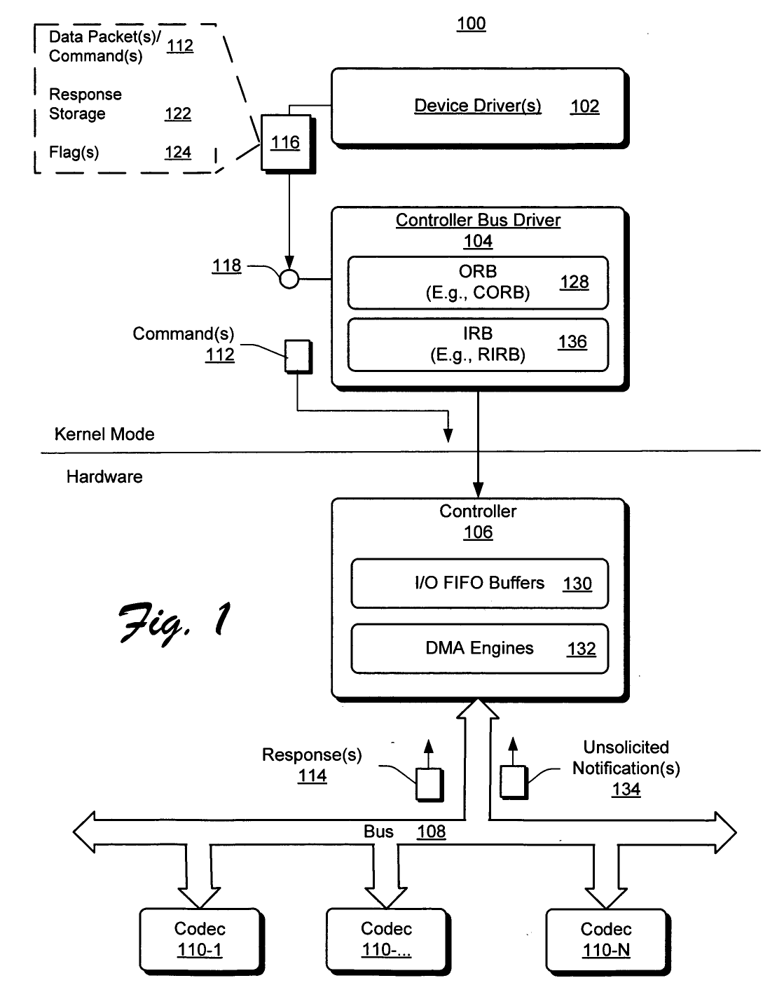

FIG. 1 shows exemplary device driver architecture 100 for managing ring input ring buffer (IRB) data transfers in a system where multiple device drivers may communicate with respective ones of multiple codecs on a one-to-one data packet (e.g., a command) and response basis. A one-to-one data packet to response basis means that for each data packet sent by a device driver to a codec, the device driver expects to receive a corresponding response from the codec. In such an environment, and because codec response(s) may be dropped due to dynamic memory allocation (DMA) engine FIFO buffer overflow(s), and because response(s) may never be generated due to malfunctioning codec(s), architecture 100 detects any such response error(s) and communicates the detected errors to corresponding device driver(s). Additionally, and as described in greater detail below, architecture 100 matches received response(s) in view of response error(s) and in view of received unsolicited notifications stored in the IRB, to corresponding ORB data packets; unsolicited notifications (if any) are forwarded to interested device drivers.

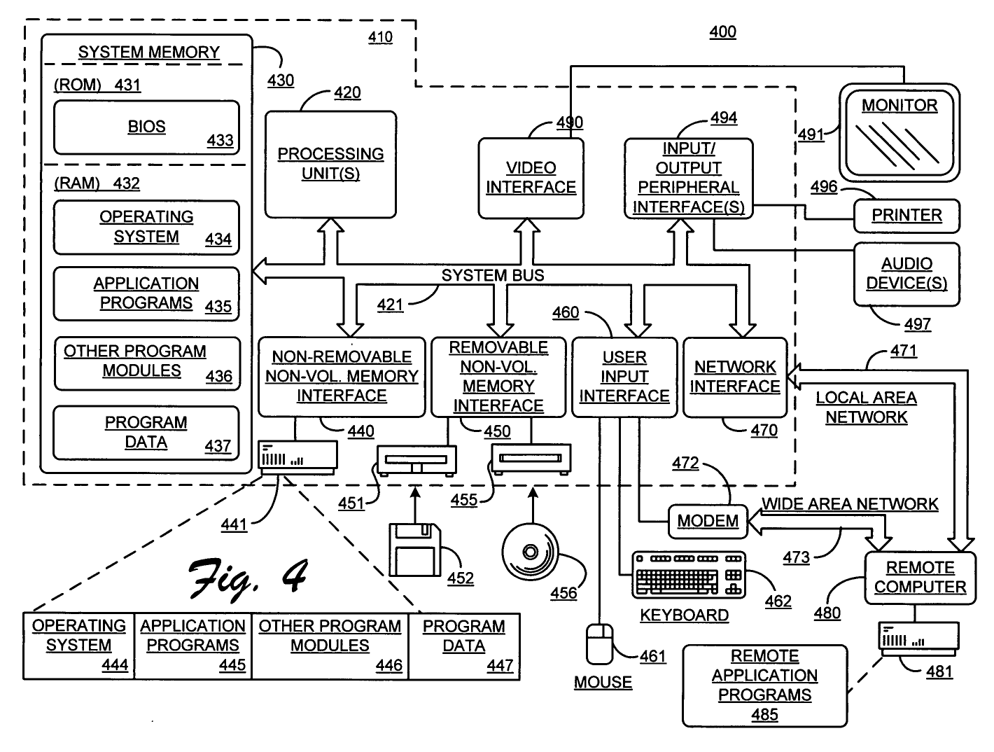

Architecture 100 is implemented in a computing device such as a general purpose computer. Components of such an exemplary computing device are described below in reference to FIG. 4. Referring to FIG. 1, device driver architecture 100 includes device driver(s) 102, controller bus driver (“bus driver”) 104, and controller 106 coupled across bus 108 to one or more codec(s) 110-1 through 110-N. In one implementation, a controller bus driver 104 is an audio controller bus driver, controller 106 is an audio controller, and a codec 110 is a High Definition (HD) audio codec connected to jacks coupled to external audio device(s), and/or internal audio device(s) (e.g., a mobile speaker). Bus 108 is an internal bus such as a High Definition Audio bus. The codec(s) 110 may be coupled to the controller through any combination of physical and wireless communication paths.

Device driver(s) 102 interface with bus driver 104 to send data packet(s) 112 (e.g., commands, etc.) to targeted ones of codec(s) 110, and to receive corresponding response(s) 114 from the targeted codec(s) 110. Each targeted codec 110 is identified by a data packet 112. In this implementation, and to send a data packet 112 to a codec 110, device driver 102 communicates transfer structure 116 to bus driver 104 via exposed device driver interface (DDI), which is an application programming interface (API) 118. Transfer structure 116 encapsulates some combination of the following data elements: data packet 112, response storage 122, and flag(s) 124. Response storage 122 is used to specify where bus driver 104 should store information from one or more responses 114 associated with the one or more data packets 112. Flag(s) 124 provide one or more flags for bus driver 104 to indicate that an expected response 114 from a codec 110 is invalid. An invalid response may represent a response 114 that was dropped due to overflow conditions at a DMA input buffer 130, as described below, or may represent a response that was never generated, for example, due to codec 110 malfunction.

Responsive to receiving a transfer structure 116, bus driver 104 stores the data packet(s) 112 into output ring buffer (ORB) 128. Bus driver 104 communicates data packet(s) 112 to a target codec 110 via controller 106. Controller 106 places the data packet 112 which are stored in the ORB 128 with the help of an output DMA engine 132 into an output FIFO buffer 130 for communication to the target codec(s) 110. Any response(s) 114 received by controller 106 from codec(s) 110 are stored into an input FIFO buffer 130. Input FIFO buffer 130 gets emptied periodically into IRB 136 by a DMA engine 132 for communication to bus driver 102. When data, such as response(s) 114 and/or unsolicited notification(s) 134, are received by bus driver 104 from controller 106 via the IRB 136, bus driver 104 processes the data stored in IRB 136.

Ideally, n data packets 112 communicated by a device driver 102 (via bus driver 104) to codec(s) 110 in a particular order, the order being represented by the ordering of the transfer structure(s) 116 in ORB 128, will result in ordered receipt of n responses 114 for storage, by controller 106, into IRB 136, wherein each response 114 maps to a particular data packet(s) 112 in ORB 128. For instance, ideally, when a first data packet 112 is sent to a first codec 110, and then a second data packet 112 is sent to the first or a different codec 110, the first response 114 received by controller 106 will map to the first data packet 112, and a second response 114 received by bus driver 102 will ideally map to the second data packet 112. This one-to-one data packet/response expectation is order of communication and receipt dependent. However, for the reasons already discussed, one to one mapping between data packet(s) 112 in ORB 128 to response(s) 114 in IRB 136 may not occur because of overflow conditions at an input FIFO buffer 130, malfunctioning codec(s) 110, and/or receipt of unsolicited notification(s) 134.

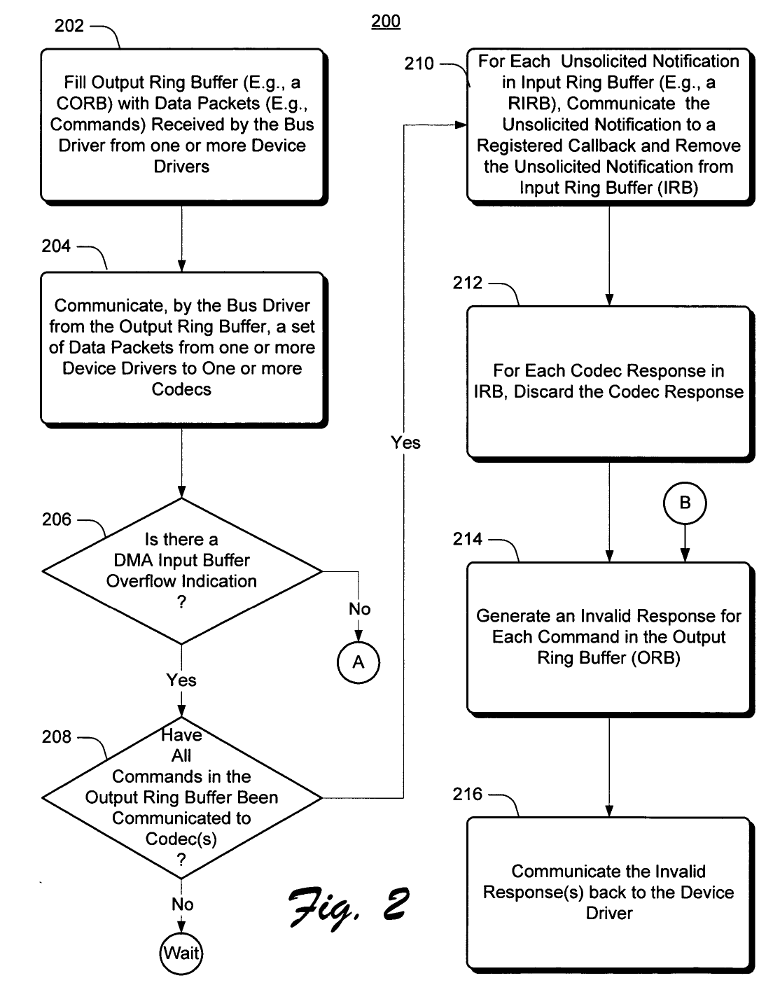

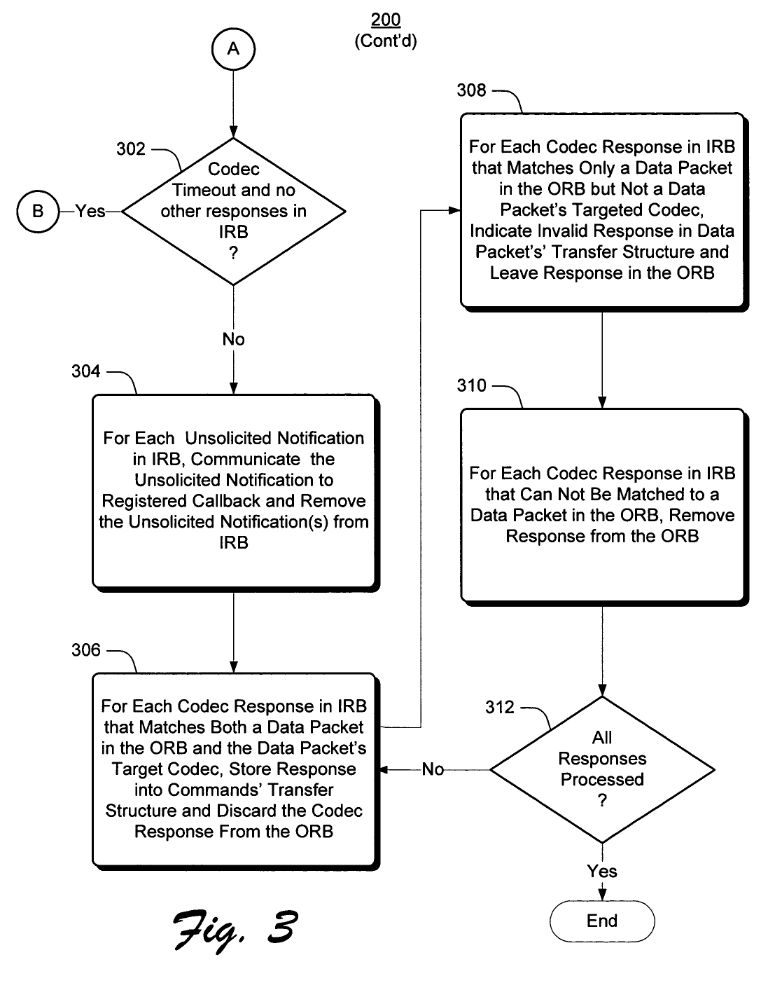

To address this, and to provide device driver(s) with corresponding response(s) 114, or indications of error in transmission of codec 110 response, bus driver 104 evaluates the data in IRB 136 according to a set of criteria as described in the exemplary operations shown of FIGS. 2 and 3, which are described below. Once response(s) 114 to data packet(s) 112 are either accounted for, or otherwise invalidated, received response(s) 114 are removed (e.g., overwritten) from IRB 136, and data packet 112 is also removed (e.g., overwritten) from ORB 128 and the response(s) 114 are stored in the Response Storage 122 of the transfer structure 116. As data in IRB 136 is being evaluated, any identified unsolicited notification(s) 134 in IRB 136 are forwarded by bus driver 104 to one or more interested device driver(s) 102. These unsolicited notification(s) 134 are also removed from IRB 136. For purposes of discussion, an interested device driver 102 is a device driver 102 that has registered a callack for use by the bus driver to forward unsolicited notification(s) 134 to the device driver 102.

An Exemplary Procedure

FIG. 2 shows an exemplary procedure 200 to manage IRB data transfers. For purposes of discussion and illustration, the operations of procedure 200 are described in reference to aspects of FIG. 1. In all figures, a left-most digit of a component or operation reference number identifies the particular figure in which the component first appears. Referring to FIG. 2, at block 202, controller bus driver 104 (FIG. 1) fills ORB 128 with data packets 112 received from one or more device driver(s) 102. At block 204, the bus driver 104 communicates data packet(s) 112 to targeted ones of codec(s) 110. At block 206, bus driver 104 determines whether there is an overflow indication for dynamic memory access (DMA) input FIFO buffer 130. This is accomplished by querying an input DMA engine 132. If there is not an overflow condition, the exemplary operations of procedure 200 continue at block 302 of FIG. 3, as shown by on page reference “A” and as described in greater detail below. Otherwise, if an overflow condition was detected, the exemplary operations of procedure 200 continue at block 208.

At block 208, bus driver 104 determines whether all data packets 112 in ORB 128 have been communicated to respective ones of the targeted codec(s) 110. If not, the procedure waits until the condition has been met. Once this condition of block 208 has been met, procedure 200 continues at block 210. At block 210, bus controller 104, for each unsolicited notification 134 identified in input ring buffer (IRB) 136, communicates the unsolicited notification 134 to an interested device driver 102, and removes the unsolicited notification 134 from the IRB 136.

At block 212, for each codec response 114 in IRB 136, bus driver 104 discards the codec response 114. At block 214, bus driver 104 generates an invalid response indication for each data packet 112 in ORB 128. In this implementation, this is accomplished by setting a respective flag 124 in the transfer packet 116 corresponding to the data packet 112, such that the flag 124 indicates an invalid response for data packet(s) 112. After the operation of block 214, data packet transfer structure 116 indicates that all data packets 112 filled into ORB 128 and sent to the respective codec 110 by bus driver 104 have resulted in an invalid response. At block 216, bus driver 104 communicates the data packet transfer structure 116 back to the device driver 102 from which the data packet transfer structure 116 originated if all data packets 112 in data packet transfer structure 116 have been processed. The device driver 102 may response to the invalid response indications as a function of its particular implementation.

FIG. 3 shows further aspects of the exemplary procedure of FIG. 2 for managing IRB data transfers. At block 302, bus driver 104 (FIG. 1) determines whether a codec 110 to which a data packet 112 has been communicated (see block 204 of FIG. 2), has timed out before sending a response 114. In one implementation, such a determination is made by setting a configurable threshold amount of time for receipt of a response 114 by bus controller 104. In one implementation, the threshold amount of time is 10 to 15 milliseconds. If determined at block 302 that the codec 110 has not communicated a response within the threshold amount of time (i.e., timed out) and no other responses from other codecs were received, operations of procedure 200 continue at block 214 of FIG. 2, as already described above. Otherwise, the operations of procedure 200 continue at block 304.

At block 304, for each unsolicited notification 134 (if any) detected in IRB 136 by bus driver 104, bus driver 104 communicates the unsolicited notification 134 to any interested device driver 102. At block 306, for each codec response 114 in IRB 136 that is determined by bus driver 104 to match both a data packet 112 in ORB 128 and the matching data packet's target codec 110, the bus driver stores contents of the response 114 to the corresponding response storage 122 portion of the transfer structure 116 and discards or otherwise removes the response 114 from IRB 136.

At block 308, for each codec response 114 determined by bus driver 104 to match only a data packet 112 in CORB 128, and not matching the associated data packet's target codec 110, bus driver 104 indicates an invalid response in the data packet's corresponding transfer structure 116. In one implementation, this is accomplished by marking a flag 124 associated with the data packet 112 with an invalid response indication. The bus driver 104 leaves the response 114 in the IRB 136. This is because a codec 110 did not answer and the response 114 is for another data packet (e.g., command) 112 that was sent to a different codec 110. For example, commands 1-3 are communicated respectively to codecs A, B, and A. If codec B does not answer, the operation of block 308 ensures that response no. 2 is assigned to command no. 3 and not command no. 2. So, in this implementation, the response is left in the IRB temporarily and response to command to codec B is marked invalid. At block 310, for each codec response 114 in IRB 136 that cannot be matched to a data packet 112 in the ORB 128, bus driver 104 removes or otherwise discards the response 114 from the ORB 128.

At block 312, it is determined if there are any more response(s) 114 that have not been processed in the IRB 136. If so, the procedure 200 continues at block 306, as described above.

An Exemplary Operating Environment

FIG. 4 illustrates an example of a suitable computing environment 400 on which the system 100 of FIG. 1 and the procedure 200 of FIGS. 1 and 2 for managing input ring buffer (IRB) data transfers may be fully or partially implemented. Accordingly, aspects of this computing environment 400 are described with reference to exemplary components and operations of FIGS. 1 through 3. The left-most digit of a component or operation (procedural block) reference number identifies the particular figure in which the component/operation first appears. Exemplary computing environment 400 is only one example of a suitable computing environment and is not intended to suggest any limitation as to the scope of use or functionality of systems and methods the described herein. Neither should computing environment 400 be interpreted as having any dependency or requirement relating to any one or combination of components illustrated in computing environment 400.

For example, in one implementation, architecture 100 is an environment that is substantially optimized for audio. Aspects of an exemplary environment optimized for audio are described in greater detail in “Intel® I/O Controller Hub 6 (ICH6) High Definition Audio/AC '97”, June 2004, which is hereby incorporated in its entirety by reference. Such an environment includes, for example, some combination of dynamic memory allocation (DMA) engine(s) that use cyclical buffers, synchronously stopping and starting multiple DMA engines at once, DMA engine with a constant bitrate, an ability to obtain a value from hardware indicating a position of either the last data fetched/flushed by the DMA engine or the data currently transferred/received to/from the codec(s). Additionally, such an environment may include codecs with audio to digital converter(s) (ADC) and digital to audio converter(s) (DAC), as well as volumn control, mixers, muxers, etc., and an interface to program ADCs and DACs.

The methods and systems described herein are operational with numerous other general purpose or special purpose computing system environments or configurations. Examples of well-known computing systems, environments, and/or configurations that may be suitable for use include, but are not limited to, personal computers, server computers, multiprocessor systems, microprocessor-based systems, network PCs, minicomputers, mainframe computers, distributed computing environments that include any of the above systems or devices, and so on. Compact or subset versions of the framework may also be implemented in computing devices of limited resources, such as handheld computers, or other computing devices. The invention is practiced in a distributed computing environment where tasks are performed by remote processing devices that are linked through a communications network. In a distributed computing environment, program modules may be located in both local and remote memory storage devices.

With reference to FIG. 4, an exemplary system for managing IRB data transfers includes a general purpose computing device in the form of a computer 410. Components of computer 410 may include, but are not limited to, processing unit(s) 420, a system memory 430, and a system bus 421 that couples various system components including the system memory to the processing unit 420. The system bus 421 connects controller 106 (FIG. 1) with the system and may be any of several types of bus structures including a memory bus or memory controller, a peripheral bus, and a local bus using any of a variety of bus architectures. By way of example and not limitation, such architectures may include Industry Standard architecture (ISA) bus, Micro Channel architecture (MCA) bus, Enhanced ISA (EISA) bus, Video Electronics Standards association (VESA) local bus, USB, Wireless, and Peripheral Component Interconnect (PCI) bus also known as Mezzanine bus or PCI Express bus.

A computer 410 typically includes a variety of computer-readable media. Computer-readable media can be any available media that can be accessed by computer 410 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 410.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example and not limitation, communication media includes wired media such as a wired network or a direct-wired connection, and wireless media such as acoustic, RF, infrared and other wireless media. Combinations of the any of the above should also be included within the scope of computer-readable media.

System memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431.

RAM 432 typically includes data and/or program modules that are immediately accessible to and/or presently being operated on by processing unit 420. By way of example and not limitation, FIG. 4 illustrates operating system 434, application programs 435, other program modules 436, and program data 438. In one implementation, operating system 434 comprises controller bus driver 104, device driver(s) 102 (or any other computer-program logic, such a computer-program, to communicate data to bus driver 104 for transfer of data across a bus 108 to a receiving entity, callbacks used to process response(s) 114 and/or unsolicited notification(s) 134), etc. Application programs 335 also include, for example, one or more computer-program applications that operate under operating system 434 that may send data (e.g., commands) to bus driver 104 for transfer across a bus 108 to a receiving entitiy such as codec(s) 110. Other program module(s) 436 includes, for example, a bus driver 104, a controller 106, etc.

Program data 437 includes, for example, transfer structure(s) 116, commands or data packet(s) 112, response(s) 114, unsolicited notification(s) 134, render and capture audio streams associated with respective ones of codec(s) 110, parameters for respective ones of data packet(s) 112, intermediate calculations, other data, etc.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446, and program data 448. Note that these components can either be the same as or different from operating system 434, application programs 435, other program modules 436, and program data 438. Operating system 444, application programs 445, other program modules 446, and program data 448 are given different numbers here to illustrate that they are at least different copies.

A user may enter information into the computer 410 through input devices such as a keyboard 462 and pointing device 461, commonly referred to as a mouse, trackball or touch pad. Other input devices (not shown) may include a microphone (audio capture) audio device, joystick, game pad, satellite dish, scanner, or the like. These and other input devices are often connected to the processing unit 420 through a user input interface 460 that is coupled to the system bus 421, but may be connected by other interface and bus structures, such as a parallel port, game port, a universal serial bus (USB), IEEE 1394 AV/C bus, PCI bus, and/or the like.

A monitor 491 or other type of display device is also connected to the system bus 421 via an interface, such as a video interface 490. In addition to the monitor, computers may also include other peripheral output devices such as audio device(s) 497 and a printer 496, which may be connected through an output peripheral interface 494. In this implementation, respective ones of input and/or peripheral interface(s) 494 encapsulate operations of audio devices 497, which include codec(s) 110 of FIG. 1.

The computer 410 may operate in a networked environment using logical connections to one or more remote computers, such as a remote computer 480. The remote computer 480 may be a personal computer, a server, a router, a network PC, a peer device or other common network node, and as a function of its particular implementation, may include many or all of the elements described above relative to the computer 410, although only a memory storage device 481 has been illustrated in FIG. 4. The logical connections depicted in FIG. 4 include a local area network (LAN) 481 and a wide area network (WAN) 483, but may also include other networks. Such networking environments are commonplace in offices, enterprise-wide computer networks, intranets and the Internet.

When used in a LAN networking environment, the computer 410 is connected to the LAN 481 through a network interface or adapter 480. When used in a WAN networking environment, the computer 410 typically includes a modem 482 or other means for establishing communications over the WAN 483, such as the Internet. The modem 482, which may be internal or external, may be connected to the system bus 421 via the user input interface 460, or other appropriate mechanism. In a networked environment, program modules depicted relative to the computer 410, or portions thereof, may be stored in the remote memory storage device. By way of example and not limitation, FIG. 4 illustrates remote application programs 485 as residing on memory device 481. The network connections shown are exemplary and other means of establishing a communications link between the computers may be used.

### CONCLUSION

Although the systems and methods for managing IRB data transfers have been described in language specific to structural features and/or methodological operations or actions, it is understood that the implementations defined in the appended claims are not necessarily limited to the specific features or actions described. Accordingly, the specific features and actions are disclosed as exemplary forms of implementing the claimed subject matter.

1. A method for managing input ring buffer data transfers, the method comprising:
communicating a set of data packets from an output ring buffer (ORB) to a codec, information associated with the data packets originating from a device driver, the data packets being stored in the ORB; and
notifying the device driver of any valid or invalid response corresponding to a data packet of the data packets.

2. A method as recited in claim 1, wherein the data packets are commands and the ORB is a command output ring buffer (CORB).

3. A method as recited in claim 1, wherein the communicating and the notifying are performed by components in a high definition (HD) audio architecture.

4. A method as recited in claim 1, wherein the invalid response is an indication that the codec timed out, or an indication that a response was lost in a First In First Out (FIFO) buffer, or an indication that a response matching the data packet was located in the IRB, but the response was from a different codec than the codec.

5. A method as recited in claim 1, further comprising removing an invalid response or an unsolicited response from the IRB.

6. A method as recited in claim 1, further comprising:
receiving the data packets from the device driver; and
storing the data packets in the ORB.

7. A method as recited in claim 1, further comprising communicating a valid response to the device driver, the valid response from the codec and being a one-to-one correspondence to a data packet of the data packets.

8. A method as recited in claim 1, and further comprising communicating an unsolicited notification from the codec the device driver.

9. A method as recited in claim 1, and further comprising:
receiving registration of a callback from the device driver; and
identifying the unsolicited notification in the IRB; and
communicating the unsolicited notification to the callback.

10. A method as recited in claim 1, wherein notifying further comprises:
determining that a dynamic memory access FIFO buffer has overflowed; and
responsive to the determining, and after all of the data packets in an output ring buffer (ORB) have been communicated to the codec or other codec(s):
for each data packet of the data packets, mapping a respective invalid response to the data packet;
communicating each respective invalid response to the device driver; and
for each response in the IRB to a data packet of the data packets removing the response from the IRB.

11. A method as recited in claim 10, and further comprising, responsive to the determining, removing all unsolicited notifications from the IRB.

12. A method as recited in claim 10, and further comprising, responsive to the determining, communicating any unsolicited notification in the IRB to an interested device driver.

13. A computer-readable medium comprising computer-executable instructions executable by a processor for managing input ring buffer data transfers in a system based on one-to-one data packet to response criteria, the computer-executable instructions comprising instructions for:
communicating a set of data packets from an output ring buffer (ORB) to a codec, information associated with the data packets originating from a device driver, the data packets being stored in the ORB; and
notifying the device driver of a valid or an invalid response corresponding to a data packet of the data packets.

14. A computer-readable medium as recited in claim 13, wherein the data packets are commands and the ORB is a command output ring buffer (CORB).

15. A computer-readable medium as recited in claim 13, wherein the communicating and the notifying are performed by components in a high definition (HD) audio architecture.

16. A computer-readable medium as recited in claim 13, wherein the invalid response is an indication that the codec timed out, or an indication that a response was lost in a First In First Out (FIFO) buffer, or an indication that a response matching the data packet was located in the IRB, but the response was from a different codec than the codec.

17. A computer-readable medium as recited in claim 13, wherein the computer-executable instructions further comprise instructions for removing an invalid response or an unsolicited response from the IRB.

18. A computer-readable medium as recited in claim 13, wherein the computer-executable instructions further comprise instructions for:
receiving the data packets from the device driver; and
storing the data packets in the ORB.

19. A computer-readable medium as recited in claim 13, wherein the computer-executable instructions further comprise instructions for communicating a valid response to the device driver, the valid response from the codec and being a one-to-one correspondence to a data packet of the data packets.

20. A computer-readable medium as recited in claim 13, wherein the computer-executable instructions further comprise instructions for communicating an unsolicited notification from the codec the device driver.

21. A computer-readable medium as recited in claim 13, wherein the computer-executable instructions further comprise instructions for:
receiving registration of a callback from the device driver;
identifying the unsolicited notification in the IRB; and
communicating the unsolicited notification to the callback.

22. A computer-readable medium as recited in claim 13, wherein the computer-executable instructions for notifying further comprise instructions for:
determining that a dynamic memory access FIFO buffer has overflowed; and
responsive to the determining, and after all of the data packets in an output ring buffer (ORB) have been communicated to the codec or other codec(s):
for each data packet of the data packets, mapping a respective invalid response to the data packet;
communicating each respective valid or invalid response to the device driver; and
for each response in the IRB to a data packet of the data packets removing the response from the IRB.

23. A computer-readable medium as recited in claim 22, wherein the computer-executable instructions further comprise instructions, responsive to the determining, for removing all unsolicited notifications from the IRB.

24. A computer-readable medium as recited in claim 22, wherein the computer-executable instructions further comprise instructions, responsive to the determining, for communicating any unsolicited notification in the IRB to an interested device driver.

25. A computing device for managing input ring buffer data transfers in a system based on one-to-one data packet to response criteria, the computing device comprising:
a processor; and
a memory coupled to the processor, the memory comprising computer-program instructions executable by the processor for:
communicating a set of data packets from an output ring buffer (ORB) to a codec, information associated with the data packets originating from a device driver, the data packets being stored in the ORB; and
notifying the device driver of an invalid response corresponding to a data packet of the data packets.

26. A computing device as recited in claim 25, wherein the communicating and the notifying are performed by an audio bus controller, and wherein the codec is a high definition codec.

27. A computing device as recited in claim 25, wherein the invalid response is an indication that the codec timed out, or an indication that a response was lost in a First In First Out (FIFO) buffer, or an indication that a response matching the data packet was located in the IRB, but the response was from a different codec than the codec.

28. A computing device as recited in claim 25, wherein the computer-executable instructions further comprise instructions for removing an invalid response or an unsolicited response from the IRB.

29. A computing device as recited in claim 25, wherein the computer-executable instructions further comprise instructions for:
receiving the data packets from the device driver; and
storing the data packets in the ORB.

30. A computing device as recited in claim 25, wherein the computer-executable instructions further comprise instructions for communicating a valid response to the device driver, the valid response from the codec and being a one-to-one correspondence to a data packet of the data packets.

31. A computing device as recited in claim 25, wherein the computer-executable instructions further comprise instructions for communicating an unsolicited notification from the codec the device driver.

32. A computing device as recited in claim 25, wherein the computer-executable instructions further comprise instructions for:
receiving registration of a callback from the device driver; and
identifying the unsolicited notification in the IRB; and
communicating the unsolicited notification to the callback.

33. A computing device as recited in claim 25, wherein the computer-executable instructions for notifying further comprise instructions for:
determining that a dynamic memory access FIFO buffer has overflowed; and
responsive to the determining, and after all of the data packets in an output ring buffer (ORB) have been communicated to the codec or other codec(s):
for each data packet of the data packets, mapping a respective invalid response to the data packet;
communicating each respective invalid response to the device driver; and
for each response in the IRB to a data packet of the data packets removing the response from the IRB.

34. A computing device as recited in claim 33, wherein the computer-executable instructions further comprise instructions, responsive to the determining, for removing all unsolicited notifications from the IRB.

35. A computing device as recited in claim 33, wherein the computer-executable instructions further comprise instructions, responsive to the determining, for communicating any unsolicited notification in the IRB to an interested device driver.

36. A computing device for managing input ring buffer data transfers, the computing device comprising:
communicating means to communicate a set of data packets from an output ring buffer (ORB) to a codec, information associated with the data packets originating from a device driver, the data packets being stored in the ORB; and
notifying means to notify the device driver of an invalid response corresponding to a data packet of the data packets.

37. A computing device as recited in claim 36, wherein the computing device further comprises removing means to remove an invalid response or an unsolicited response from the IRB.

38. A computing device as recited in claim 36, wherein the computing device further comprises:
receiving means to receive the data packets from the device driver; and
storing means to store the data packets in the ORB.

39. A computing device as recited in claim 36, wherein the computing device further comprises communicating means to communicate a valid response to the device driver, the valid response from the codec and being a one-to-one correspondence to a data packet of the data packets.

40. A computing device as recited in claim 36, wherein the computing device further comprises:
determining means to determine that a dynamic memory access FIFO buffer has overflowed; and
responsive to the determining, and after all of the data packets in an output ring buffer (ORB) have been communicated to the codec or other codec(s):
for each data packet of the data packets, mapping means to map a respective invalid response to the data packet;
communicating means to communicate each respective invalid response to the device driver; and
for each response in the IRB to a data packet of the data packets removing means to remove the response from the IRB.
